(19) United States
(12) Patent Application Publication
(10) Pub. No.: US 2012/0038597 A1
(43) Pub. Date: Feb. 16, 2012

(54) PRE-PROGRAMMING OF IN-PIXEL NON-VOLATILE MEMORY

(76) Inventors: Michael P. COULSON, Oxford (GB); Sunay Shah, Oxford (GB); Benjamin J. Hadwen, Oxford (GB)

(21) Appl. No.: 12/853,359

(22) Filed: Aug. 10, 2010

(51) Int. Cl. G09G 5/00; G09G 3/36

(52) U.S. Cl. 345/204; 345/87

(57) ABSTRACT

A display device includes a liquid crystal display having a plurality of pixels, each pixel having a corresponding pixel electrode. Each pixel also includes a volatile memory (VM) cell and a non-volatile memory (NVM) cell. The VM cell includes a VM cell input for receiving data to be stored in the VM cell and a VM cell output for outputting data stored in the VM cell. The NVM cell includes an NVM program input operatively coupled to the VM cell output, and an NVM data output for providing data stored in the first NVM cell to the pixel electrode. The display device also includes programming logic operatively coupled to each of the plurality of pixels, wherein the programming logic is configured to substantially simultaneously program each pixel's first NVM cell with data provided by each pixel's VM cell.

### TECHNICAL FIELD

The present invention relates to active matrix liquid crystal displays, and more particularly, to active matrix displays having non-volatile memory within each pixel.

### BACKGROUND ART

An image is formed on a liquid crystal display (LCD) by controlling the amount of light passing to the viewer's eye from each pixel. This light may originate from a backlight situated behind the display, in which case the display is termed ‘transmissive’. Alternatively, the light may originate from ambient sources in front of the display, in which case the display is termed ‘reflective’. The backlight of a transmissive display consumes significant power, and so reflective displays are preferred for applications where power consumption is of critical importance. Photovoltaic and battery powered devices are examples of such applications.

The cross section of a reflective active matrix LCD is shown in FIG. 1. The LCD principally comprises two sheets of glass, between which a thin layer of liquid crystal 102 is contained. The amount of light passing to the viewer's eye 104 is controlled by the local electric field that is applied across the liquid crystal layer 102 at each pixel. This electric field is applied between a common electrode 106, deposited onto the lower surface of the upper glass 108, and reflective pixel electrodes 110, formed on the upper surface of the lower glass 112. The pixels share a matrix of row and column tracks, and so voltages are assigned to the pixel electrodes one row at a time. With further reference to FIG. 2, in a typical active matrix LCD each pixel contains an analogue dynamic RAM (DRAM) cell 200, so that the assigned voltage is preserved until the pixel is next addressed.

The DRAM cells 200 are fabricated on the lower glass 112, and each comprises a thin film transistor (TFT) 202 and a capacitor 204, as shown in the pixel circuit of FIG. 2. A certain row of pixels is selected by raising the voltage of the corresponding gate line (labeled GL) 206. This causes all the TFTs in that row to conduct, connecting each pixel's capacitor 204 to its corresponding source line (labeled SL) 208. The image data for the selected row of pixels is supplied as analogue voltages on the source lines, and the capacitor in each pixel is charged accordingly. Once the capacitors have been charged, the gate line voltage is brought low, and the TFTs cease to conduct. In this way, the voltage stored upon each capacitor is preserved until the row is next addressed. Note that the stored voltage forms the output of the DRAM cell (labeled OUT) and is applied directly to the LC 102.

In practice, however, a TFT is a non-ideal switch and passes a finite leakage current in its non-conducting state. Charge therefore leaks from the capacitors, and so the retention time of the DRAM cells is in the order of milliseconds. For this reason the data must be re-written to the pixels on a regular basis, typically at a rate of 60 Hz. FIG. 3 shows that the display 302, comprising pixel matrix 304 and integrated driver circuits 306, is accompanied by at least one external IC 308 within the host device 310. At least one of the external ICs stores the image data whilst it is repeatedly written to the display. Both this external IC and the display driver circuits 306 must operate continuously whilst the pixel matrix is being addressed, and this represents a significant source of power consumption.

In certain applications, it is desirable to use a non-volatile memory (NVM) in place of the DRAM within each pixel. Unlike a DRAM, an NVM may store data almost indefinitely, and so the pixel matrix does not need to be refreshed. This means that power consumption is reduced. Furthermore, the contents of the NVM are not lost each time the power is switched off, and so there is no need to write data to the pixels each time the power is restored. Indeed, the in-pixel NVM may preclude the need for external memory ICs altogether, reducing the cost and physical dimensions of the display. The use of NVM in the pixels of an LCD is well known, and is described by U.S. Pat. No. 4,112,333 (Asars et al., Sep. 5, 1978). The use of both NVM and conventional RAM in the same pixels is also known, and is described by US patent application US2002/0021295A1 (Koyama et al., Feb. 21, 2002).

Many forms of NVM are known, including those based upon ferroelectric materials (FeRAM), and those based upon floating gate TFTs (FGTFTs). The use of both FeRAM and FGTFT memory within the pixels of an LCD is described by U.S. Pat. No. 7,151,511 (Koyama, Dec. 19, 2006).

When the NVM is implemented using an FGTFT, it may take the form shown in FIG. 4, where the NVM cell 400 comprises transistors 402, 404, and 406. The gates of TFTs 402, 404 and 406 are connected to a floating gate electrode (labeled FG) 408, which is insulated from all other conductors and therefore capable of storing charge. The drain and source of control gate TFT 402 are connected together and form the control gate 410. The control gate TFT 402 serves as a capacitor, allowing the voltage at the control gate 410 to capacitively influence that of the floating gate 408.

The FGTFT can be used as a memory by changing the amount of charge stored on its floating gate. The amount of stored charge influences the potential of the floating gate 408 with respect to the control gate 410. By sensing this potential, the contents of the memory may be determined.

To program the NVM, a large positive voltage is applied to the control gate 410, whilst a large negative voltage is applied to the cell's programming input, which is the drain 412 of the programming TFT 406. This causes electrons to pass through the gate oxide of the programming TFT 406 and onto the floating gate 408. The erase input, which is the drain 414 of the erase TFT 404, is maintained at 0V throughout.

To erase the NVM, a large negative voltage is applied to the control gate 410, whilst a large positive voltage is applied to the erase input 414. This causes electrons to pass from the floating gate, through the gate oxide of the erase TFT 404. The programming input 412 is held at 0V throughout. The source of the erase TFT 404 and the source of the programming TFT 406 are connected together at point 416 (COM), and are typically held at 0V whilst the NVM cell is programmed or erased.

Certain NVM technologies are limited to storing digital rather than analogue information. In order for these technologies to permit multiple levels of greyscale, or equivalently a greater colour depth, it is possible to use multiple NVM cells within each pixel (hereafter termed ‘multi-bit’). Multiple NVM cells may also be used to store data for several different frames within a single pixel (hereafter termed ‘multi-frame’). This allows one of a number of predefined images to be displayed without addressing the matrix.

The concepts of multi-bit and multi-frame memory in pixel are described by US patent application US2002/0024485A1 (Koyama, Feb. 28, 2002), which is summarised by FIG. 5. FIG. 5 shows one pixel, containing six memory circuits arranged in three groups: 502, 504 and 506. Each group represents one bit of greyscale resolution, and the two memory cells within each group represent two different frames. Memory cells 508A, 510A and 512A correspond to frame ‘A’, whereas memory cells 508B, 510B and 512B correspond to frame ‘B’. Either frame A or frame B may be selected for programming or display using the switches 514 and 516 respectively. A particular bit may be selected for programming using the gate line 518, 520 or 522. A particular bit may be selected for display using the gate line 524, 526 or 528. A pulse width modulation scheme may be used to assign binary weights to the three bits; each bit is connected to the pixel electrode in turn, but the most significant bit is connected to the pixel electrode for eight times longer than the least significant bit.

It is important to note that the liquid crystal will suffer chemical degradation if subjected to a DC electric field for a prolonged period of time. In a conventional DRAM-based active matrix LCD, the polarity of the voltage written to any given pixel is inverted on each occasion that it is addressed. In displays having NVM in place of DRAM, pixel addressing might not take place for several seconds, or even minutes. This is equally true for displays having SRAM instead of DRAM. It is necessary for such displays to provide a means of inverting the voltage applied to every pixel electrode, without the matrix being addressed. This is called ‘in-pixel inversion’, and circuits for performing in-pixel inversion are well known in the prior art.

One possible circuit for performing in-pixel inversion is shown in FIG. 6. The digital output voltage from the in-pixel memory is connected to 602, and so controls the conducting state of TFTs 604 and 606. These TFTs connect the pixel electrode 608 to either pixel voltage a 610 or pixel voltage b 612. Pixel voltage a 610 and pixel voltage b 612 are global signals supplied to the entire matrix. Pixel voltage a is typically maintained equal to the voltage of the common electrode 106; when a pixel electrode is connected to pixel voltage a, no electric field is present across the LC 102. Pixel voltage b is typically alternated between positive and negative voltages with respect to the common electrode; when a pixel electrode is connected to pixel voltage b, an alternating field with zero mean voltage is present across the LC. In this way, the LC field may be inverted without the matrix being addressed. Note that the input 602 of the circuit shown in FIG. 6 presents a high impedance, and may therefore be directly connected to the floating gate of an FGTFT. Note also that the floating gate is typically programmed to take a negative voltage with respect to the control gate, and is erased to take a similar voltage to the control gate. The control gate must be held at an appropriate voltage during display operation, in order to offset the range of floating gate voltages to that required by the in-pixel inversion circuitry.

In the circuit of FIG. 6, the voltage swing at the output of the in-pixel memory, which is connected to the input of the inversion circuitry 602, must exceed the voltage swing of signals 610 and 612. This is because TFTs 604 and 606 will not otherwise pass the full swing of signals 610 and 612 to the pixel electrode 608. An alternative circuit for performing in-pixel inversion is shown in FIG. 7. In this case, the TFTs 604 and 606 have been replaced with pass gates 702. These pass gates are capable of passing the full voltage swing of the signals 610 and 612 to the pixel electrode, even if the voltage swing at their gates is no larger than that of the signals 610 and 612. As the pass gates 702 require complimentary inputs, an inverter is provided, comprising TFTs 704 and 706. This inverter is driven between power rails 708 and 710. Like the circuit of FIG. 6, the input 712 presents a high impedance, and may be directly connected to the floating gate of an FGTFT.

Note that when the FGTFT NVM is programmed and erased, charge is transferred to and from the floating gate 408 at a finite rate. The program or erase voltages must therefore be maintained for some time: potentially as long as 100 ms, depending on factors such as the voltages applied and the physical properties of the gate oxide. This is a disadvantage of using NVM within a pixel matrix: each cell may take significantly longer to program than DRAM or SRAM. In the prior art, the pixels are addressed via a matrix of row and column tracks, and the NVM cells are programmed one row at a time. If an NVM cell takes 100 ms to program, and there are 100 rows in the matrix, then 10 seconds are required to program the entire display. This is an unacceptably long time for most applications.

### SUMMARY OF INVENTION

A device and method in accordance with the present invention aims to reduce the time taken for an entire pixel matrix of NVM cells to be programmed. This is achieved by programming every NVM cell simultaneously, rather than programming one row at a time. In order to allow the entire matrix to be programmed simultaneously, each pixel contains a conventional DRAM cell in addition to its NVM cell. Programming is carried out in two steps. First, the DRAM cells are programmed row-by-row, which takes very little time. Secondly, the contents of each DRAM cell is transferred into its corresponding NVM cell. No pixel addressing is required for this second step, so it may occur simultaneously for every pixel in the matrix.

The device and method in accordance with the present invention reduces the time required to selectively program NVM cells across the entire pixel matrix of an LCD. This is achieved by programming every pixel's NVM cell simultaneously, which is not normally possible. If each row takes 100 ms to program, then a display having 100 rows would normally take 10 seconds to program. However, in accordance with the present invention, the same display will take only 100 ms to program. This makes the NVM-in-pixel display suitable for applications such as smart cards, where the display is only in contact with the programming device for a brief period of time.

According to one aspect of the invention, a pixel of a display device includes: a pixel electrode; a volatile memory (VM) cell including a VM cell input for receiving data to be stored in the VM cell and a VM cell output for outputting data stored in the VM cell; and a non-volatile memory (NVM) cell including an NVM program input operatively coupled to the VM cell output, and an NVM data output for providing image data stored in the first NVM cell to the pixel electrode.

According to one aspect of the invention, an active matrix display includes a plurality of pixels as set forth herein, and programming logic operatively coupled to each of the plurality of pixels, wherein the programming logic is configured to substantially simultaneously program each pixel's NVM cell with data stored in each pixel's VM cell.

According to one aspect of the invention, the programming logic is configured to program the NV cells row-by-row and then simultaneously program the NVM cell with the data stored in the VM cell.

According to one aspect of the invention, each NVM cell comprises an NVM control gate, and the NVM control gate of each pixel of the plurality of pixels is electrically coupled to the NVM control gate of other pixels of the plurality of pixels.

According to one aspect of the invention, each NVM cell comprises an NVM erase input, and the NVM erase input of each pixel of the plurality of pixels is electrically coupled to the NVM erase input of other pixels of the plurality of pixels.

According to one aspect of the invention, the pixel further includes inversion circuitry including an inversion input and an inversion output, the inversion input operatively coupled to the NVM data output of the NVM cell, and the inversion output operatively coupled to the pixel electrode, the inversion circuitry configured to invert a voltage applied to the pixel electrode.

According to one aspect of the invention, the pixel further includes a gating device including a gating device input for receiving a current, a gating device output operatively coupled to the NVM program input, and a gating device enable operatively coupled to the VM cell output, wherein the gating device is configured to electrically connect the gating device input to the gating device output based on a state of the gating device enable.

According to one aspect of the invention, the VM cell, NVM cell, inversion circuitry and gating device form a first memory unit, the pixel further including: a second memory unit including another VM cell, NVM cell, inversion circuitry and gating device, the first and second memory units each having a memory unit input for receiving data to be stored in the VM cell of the respective memory unit, and memory unit output for providing image data to be displayed by the pixel; a first select device including an input operatively coupled to the first memory unit output, an output operatively coupled to the pixel electrode, and an enable input configured to selectively couple the input of the first select device to the output of the first select device; and a second select device including an input operatively coupled to the second memory unit output of the second memory unit, an output operatively coupled to the pixel electrode, and an enable input configured to selectively couple the input of the second select device to the output of the second select device, wherein based on a state of the enable inputs of the first and second select devices, the memory unit output of the first or second memory unit is coupled to the pixel electrode.

According to one aspect of the invention, the NVM cell, inversion circuitry and gating device form a first memory unit, the pixel further includes: a second memory unit including another NVM cell, inversion circuitry and gating device, the first and second memory units each having a memory unit first and second programming inputs for receiving data to be stored in the respective NVM cell, and a memory unit output for providing image data to be displayed by the pixel, wherein the first memory unit input of each memory unit is operatively coupled to the VM cell output; a first select device including an input operatively coupled to the first memory unit output, an output operatively coupled to the pixel electrode, and an enable input configured to selectively couple the input of the first select device to the output of the first select device; and a second select device including an input operatively coupled to the second memory unit output, an output operatively coupled to the pixel electrode, and an enable input configured to selectively couple the input of the second select device to the output of the second select device, wherein based on a state of the enable inputs of the first and second select devices, the memory unit output of the first or second memory unit is coupled to the pixel electrode.

According to one aspect of the invention, the memory unit second input of the first and second memory units are coupled to different programming lines.

According to one aspect of the invention, the VM cell input comprises a pixel gate line, the device further including: a readout electrode; and a readout device including a readout device input operatively coupled to the pixel electrode, a readout device output operatively coupled to the readout electrode, and readout device enable operatively coupled to the pixel gate line, the readout device configured to selectively couple the readout device input to the readout device output based on a state of the readout device enable.

According to one aspect of the invention, the readout electrode of pixels of a column are electrically connected to each other.

According to one aspect of the invention, the NVM cell of the pixel further includes an NVM erase input for erasing data stored in the NVM cell, the device further including: an erase device including an erase device input for receiving an erase voltage, an erase device output operatively coupled to the NVM erase input, and an erase device enable operatively coupled to the VM cell output, wherein the erase device is configured to couple the erase input to the erase output based on a state of the erase device enable.

According to one aspect of the invention, the VM cell input comprises a pixel gate line and a pixel source line, and data provided on the pixel source line is stored in the VM cell based on a state of the pixel gate line.

According to one aspect of the invention, a method is provided for storing data to be displayed on a display device that includes a liquid crystal display having a plurality of pixels, each pixel including a volatile memory (VM) cell and a non-volatile memory (NVM) cell. The method includes writing data in the VM cell of each pixel; and substantially simultaneously writing the data stored in each VM cell into the NVM cell of each pixel.

According to one aspect of the invention, writing data in the VM cell includes writing the data row-by-row.

According to one aspect of the invention, substantially simultaneously writing the data stored in each VM cell into the NVM cell includes writing to the NVM memory cell without using pixel addressing.

According to one aspect of the invention, the method further includes inverting a voltage applied to a pixel electrode.

According to one aspect of the invention, the method further includes providing leakage current to the NVM cell directly from the VM cell.

According to one aspect of the invention, the method further includes providing leakage current to the NVM cell from a switching device controlled by an output of the VM cell.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 is a simplified cross section of an exemplary reflective liquid crystal display.

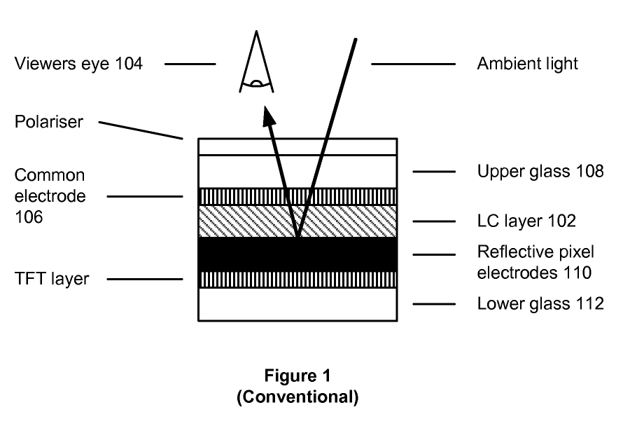

FIG. 2 is a schematic diagram of a conventional active-matrix LCD pixel circuit.

FIG. 3 is a block diagram of an exemplary host device containing an LCD and discrete memory.

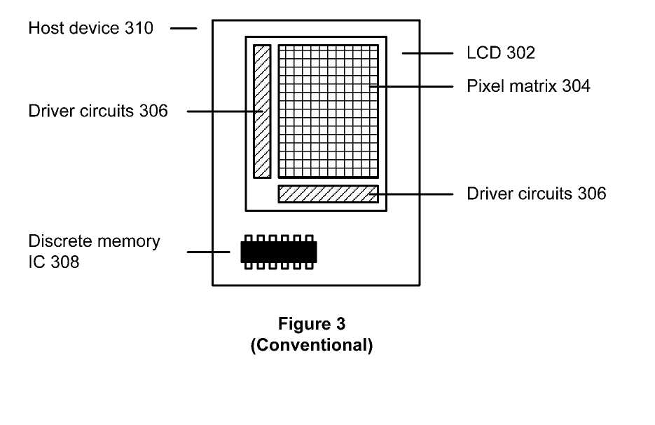

FIG. 4 is a schematic diagram of a simple FGTFT NVM cell.

FIG. 5 is a schematic diagram of multi-frame, multi-bit pixel with both NVM and RAM.

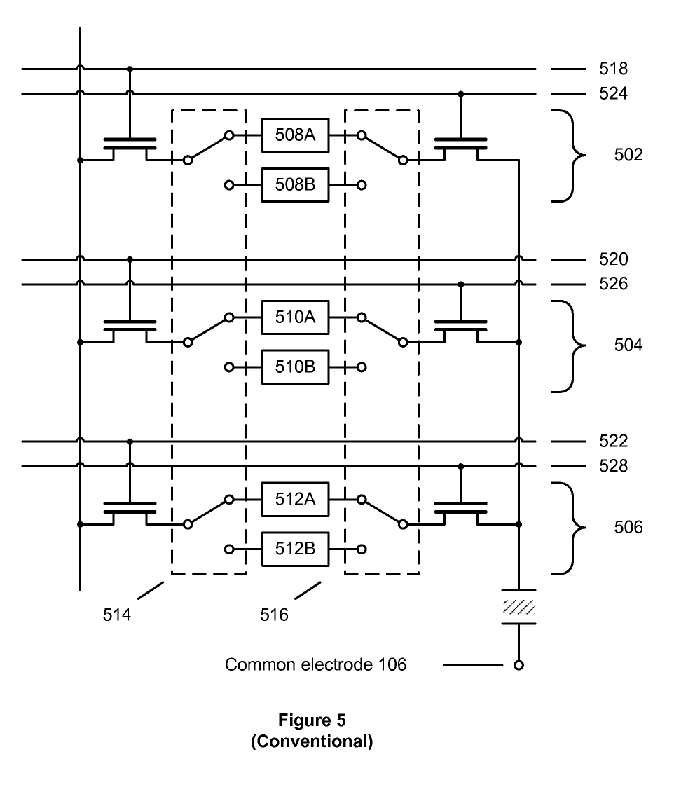

FIG. 6 is a schematic diagram of a simple in-pixel inversion circuit.

FIG. 7 is a schematic diagram of an exemplary in-pixel inversion circuit that uses pass gates.

FIG. 8 is a schematic diagram of an exemplary pixel circuit with NVM, according to a first embodiment of the invention.

FIG. 9 is a schematic diagram of an exemplary pixel circuit with NVM, according to a second embodiment of the invention.

FIG. 10 is a schematic diagram of an exemplary pixel circuit with NVM and means for verification, according to a third embodiment of the invention.

FIG. 11 is a schematic diagram of an exemplary ‘NVM unit’, which finds use in a fourth embodiment of the invention.

FIG. 12 is a schematic diagram of an exemplary pixel circuit with multi-frame NVM, according to a fourth embodiment of the invention.

FIG. 13 is a schematic diagram of an exemplary ‘NVM unit’, which finds use in a fifth embodiment of the invention.

FIG. 14 is a schematic diagram of an exemplary pixel circuit with multi-frame NVM, according to a fifth embodiment of the invention.

FIG. 15 is a schematic diagram of an exemplary pixel circuit with multi-frame NVM and means for verification, according to a sixth embodiment of the invention.

FIG. 16 is a schematic diagram of an exemplary pixel circuit with NVM, with provision for gating both the program and drain signals, according to a seventh embodiment of the invention.

FIG. 17 is a system level block diagram of a display having both volatile and non-volatile memory within each pixel, and having a controller chip that writes image data to the pixels.

### DETAILED DESCRIPTION OF INVENTION

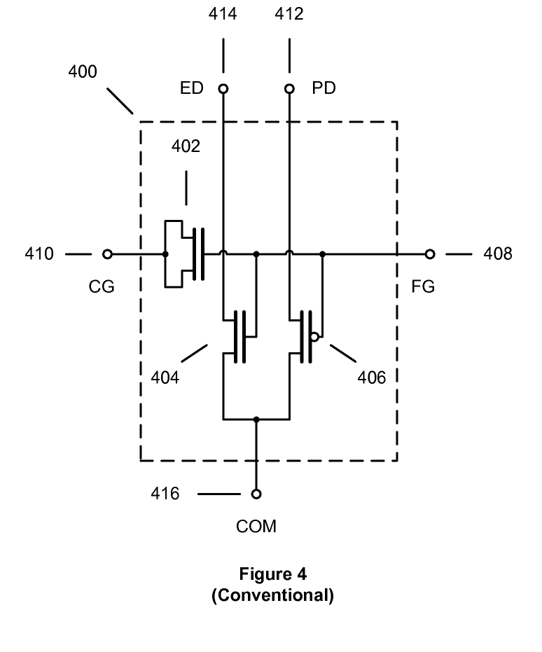

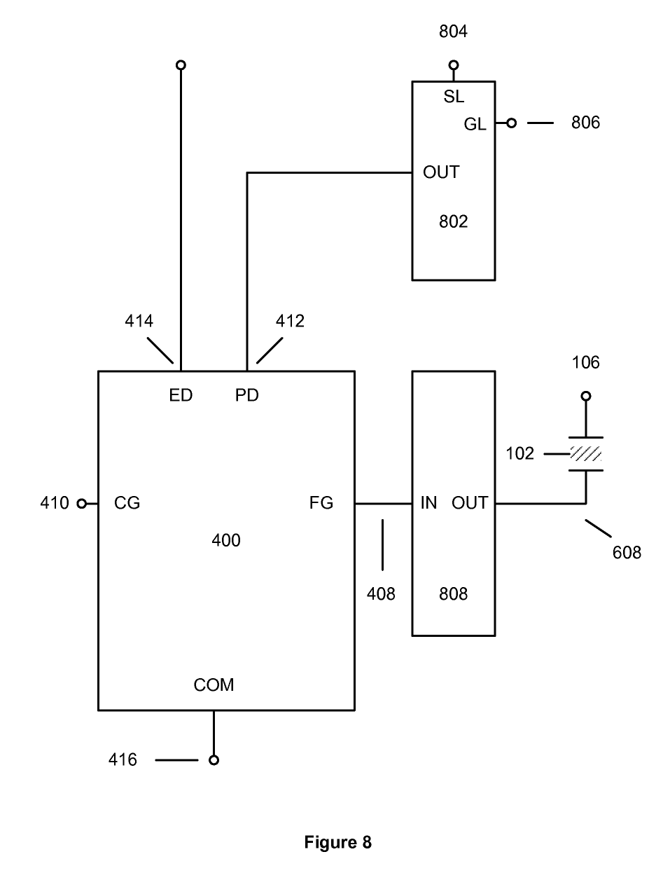

A first embodiment of the invention is shown in FIG. 8. FIG. 8 shows a schematic block diagram of one pixel of a plurality of pixels of a liquid crystal display device arranged in a matrix. A RAM cell 802 (also referred to as volatile memory (VM) cell) is connected to the pixel's source line 804 and gate line 806 (the combination of the pixel source and gate lines forming a VM cell input). The output of a RAM cell 802 (referred to as VM cell output) is connected to the programming input 412 of a non-volatile memory (NVM) cell 400 (the programming input referred to as NVM programming input). The NVM cell can be a conventional NVM cell, such as the kind described in FIG. 4 or other known

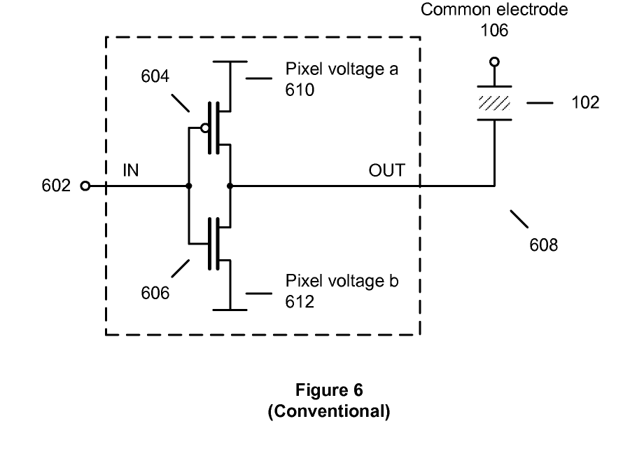

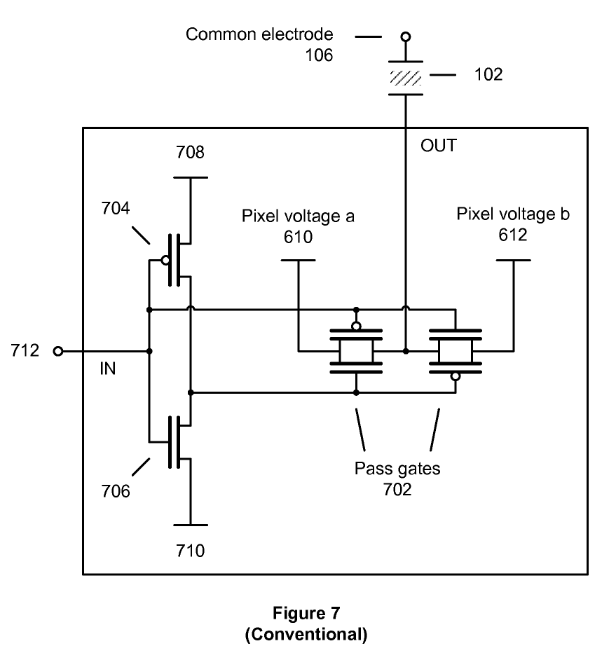

NVM cells. The floating gate (labeled FG and referred to as NVM data output) 408 of the NVM cell is connected to the input (labeled IN and referred to as inversion input) of an in-cell inversion circuitry 808. The in-cell inversion circuitry 808 may be a conventional circuit of the type shown in FIG. 6 and FIG. 7 or other known in-cell inversion circuitry. The output of the in-cell inversion circuitry (labeled OUT and referred to as inversion output) is connected to the pixel electrode 608. The pixel electrode is separated from the common electrode 106 by the LC layer 102. The control gate (labeled CG and referred to as NVM control gate) 410 of the NVM cell 400 is matrix common, meaning that the control gate of every pixel in the matrix is connected together, and is connected to a single signal line. The erase input (labeled ED and referred to as NVM erase input) 414 of the NVM cell 400 is also matrix common. The sources (labeled COM) 416 of the NVM cell's programming and erase TFTs are permanently connected to 0V.

The RAM cell 802 may be rapidly programmed in the manner of a conventional active matrix LCD pixel (e.g., row-by-row), whereby it stores the data present on the source line 804 when it is addressed using the gate line 806. In order to program a particular NVM cell 400, its corresponding RAM cell 802 is programmed with a large negative voltage, typically more negative than −10V. Whilst this voltage is applied by the RAM cell to the programming input (PD) 412 of the NVM cell, the control gate (labeled CG) 410 is raised to a large positive voltage. After a suitable amount of time has passed, typically 100 ms, the RAM cell is programmed once again with zero volts. This causes the programming voltage to be removed from the programming input (PD) 412 of the NVM cell 400, and so programming ends.

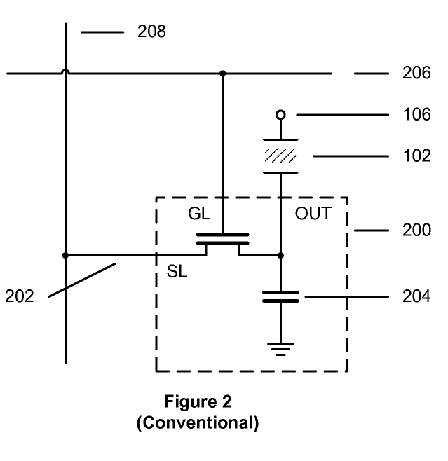

During programming of the NVM cell 400 (which occurs without pixel addressing), the programming TFT 406 (see, e.g., FIG. 4) remains in the ‘off’ regime, and so only leakage currents flow from the output (labeled OUT) of the RAM cell 802. When the RAM cell 802 is implemented as a conventional DRAM, as shown, for example, in FIG. 2, the DRAM capacitor 204 should be large enough to ensure that the programming voltage does not decay excessively given the anticipated leakage currents.

Every NVM cell 400 is erased simultaneously by applying a large negative voltage to the common control gate (labeled CG) 410, whilst applying a large positive voltage to the common erase input (labeled ED) 414. This causes electrons to tunnel away from the floating gate, as described in the prior art.

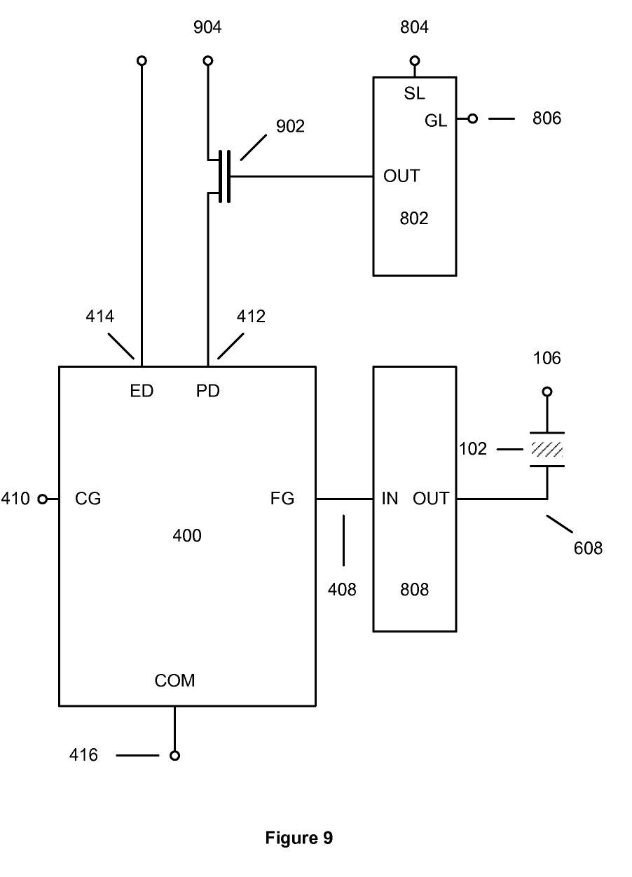

In a second embodiment of the invention, shown in FIG. 9, a TFT 902 (referred to as a gating device) is situated between the RAM 802 and the programming input (labeled PD) 412 of the NVM cell 400. The gate of the TFT 902 (referred to as the gating device enable) is connected to the output (labeled OUT) of the RAM cell 802, whilst the source of the TFT 902 (referred to as the gating device output) is connected to the programming input (labeled PD) 412 of the NVM cell 400. Programming of the NVM cells takes place in two steps. Firstly, each RAM cell is programmed with either 0V (if the NVM cell is be programmed) or a large negative voltage typically exceeding −10V (if the NVM cell is not to be programmed). Secondly, NVM cells throughout the entire pixel matrix are programmed simultaneously by application of a large negative voltage, typically exceeding −10V, to the drain 904 of the TFT 902. The drain 904 (referred to as the gating device input) is connected to a matrix common signal, which is supplied to every pixel simultaneously, yet does not reach the programming input (labeled PD) 412 of the NVM cell 400 if the RAM cell 802 has been programmed with a large negative voltage.

The control gate 410 is also connected to a matrix common signal, which is supplied to every pixel simultaneously. A substantial positive voltage is applied to the control gate 410 during the time for which the matrix common programming input is being applied to the drain 904 of each TFT 902. In order for a cell to be programmed, it must be supplied with appropriate voltages at both its control gate terminal 410 and its programming input 412. For this reason, only the intended cells will be programmed, despite the fact that the control gate signal is common to every cell in the matrix.

This second embodiment may be advantageous over the first embodiment, as the RAM cell 802 is not required to supply the finite leakage current that flows through the programming TFT 406, whilst the NVM cell is being programmed. Instead, the leakage current is supplied through the TFT 902. This allows the size of the DRAM capacitor 204 to be reduced, and may therefore reduce the required substrate area.

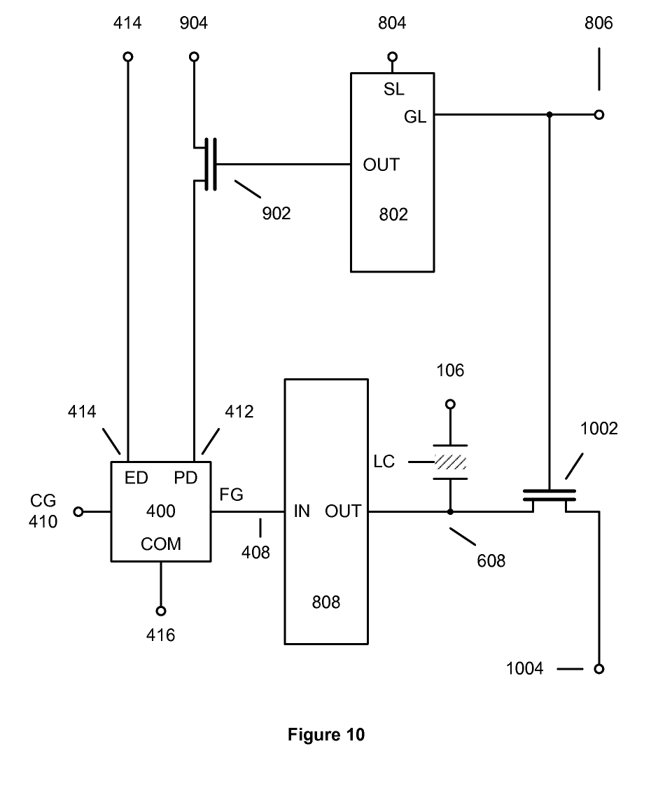

A third embodiment of the invention, shown in FIG. 10, is similar to the second embodiment but with the addition of a readout TFT 1002 (referred to as readout device) and a readout column line 1004. The readout column line 1004 is common to all the pixels in a given column. The drain of the readout TFT 1002 (referred to as readout device input) is connected to the pixel electrode 608, whilst the source of the readout TFT 1002 (referred to as the readout device output) is connected to the readout column line 1004. The gate of TFT 1002 (referred to as the readout device enable) is connected to the pixel's gate line 806. These additional components allow the data stored in the NVM cell of each pixel to be read-out and verified after the cell has been programmed. Once the programming signal is no longer being issued to the node 904, one particular gate line 806 may be raised in voltage, causing the TFT 1002 to conduct, and connecting the output of each pixel in the row to its associated column readout line 1004. The output voltage produced by each pixel may then be measured using standard techniques. Note that during readout, the voltage applied to the gate line must be chosen to allow the readout TFT 1002 to pass the voltage present at the pixel electrode 608. It may be preferable to apply one or more intermediate voltages to the matrix-common control gate (labeled CG) 410 during readout, in order to infer the amount of charge held on the floating gate.

This third embodiment may be advantageous over the second in cases where it is necessary to verify that each NVM cell has been successfully programmed or erased.

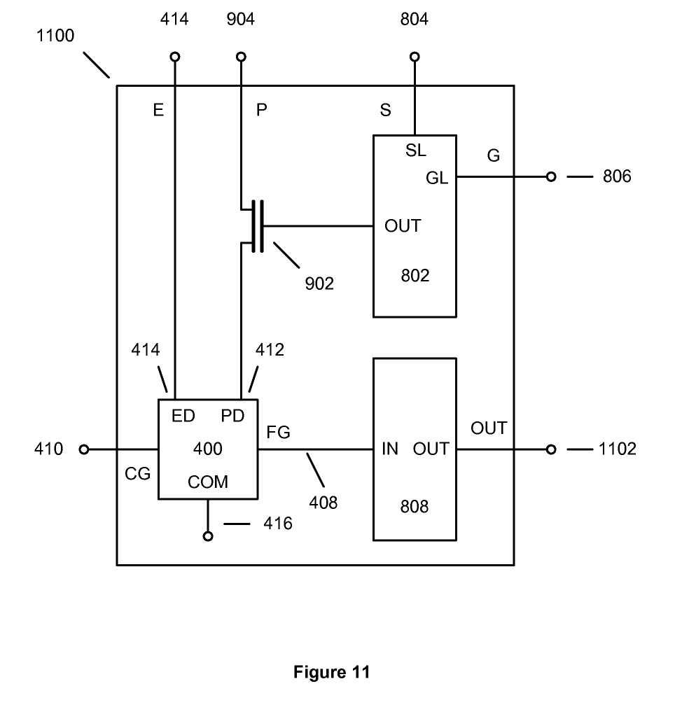

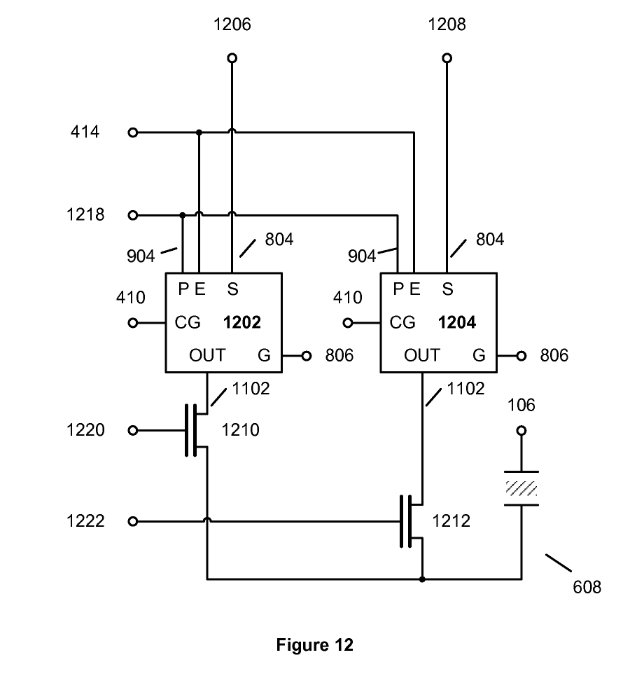

A fourth embodiment of the invention is shown in FIG. 11 and FIG. 12. In certain situations this fourth embodiment is advantageous over the previous embodiments, as multiple images may be stored within the pixel matrix. FIG. 11 shows a schematic diagram of an ‘NVM unit’ 1100, containing an NVM cell 400, inversion circuitry 808, RAM 802, and a gating TFT 902. The RAM cell 802 is connected to the NVM unit's source line input (labeled S) 804 and gate line input (labeled G) 806 (the source and gate lines are referred to as memory unit first input and memory unit second input, respectively, or collectively as a memory unit input). The output of the RAM cell (labeled OUT) 802 is connected to the gate of the gating TFT 902 (referred to as gating device enable). The source of the gating TFT 902 (referred to as gating device output) is connected to the programming input (PD) 412 of the NVM cell 400. The drain 904 of the gating TFT 902 (referred to as gating device input) forms the programming input (labeled P, referred to a memory unit programming input) of the NVM unit 1100. The NVM cell may be a conventional NVM cell (e.g., of the kind shown in FIG. 4. The floating gate (labeled FG) 408 of the NVM cell is connected to the input (labeled IN) of the in-cell inversion circuitry 808. The in-cell inversion circuitry may take the form of a conventional circuit such as, for example, the circuits shown in FIG. 6 and FIG. 7. The output (labeled OUT) of the in-cell inversion circuitry forms the output (labeled OUT, referred to as memory unit output) 1102 of the NVM unit. The control gate (labeled CG, referred to as memory unit control gate) 410 of the NVM cell 400 forms an input (labeled CG) to the NVM unit. The sources 416 of the NVM cell's program and erase TFTs are connected to 0V. The memory unit 1100 also includes a control gate input (labeled CG, referred to as memory unit control gate) and an erase input (labeled E, referred to as memory unit erase input).

FIG. 12 shows the schematic diagram of a single pixel, which is provided with two identical NVM units 1202 and 1204, of the kind shown in FIG. 11. Unlike a conventional pixel matrix, each column of the pixel matrix has two separate source lines 1206 and 1208. The source line input (labeled S) 804 of the first NVM unit 1202 is connected to the first source line 1206. The source line input (labeled S) 804 of the second NVM unit 1204 is connected to the second source line 1208. The output (labeled OUT, referred to as first memory unit output) 1102 of NVM unit 1202 is connected to the drain of a TFT 1210 (referred to as an input of a first select device), and the source of the TFT 1210 (referred to as an output of the first select device) is connected to the pixel electrode 608. The output (labeled OUT, referred to as a second memory unit output) 1102 of NVM unit 1204 is connected to the drain of a TFT 1212 (referred to as an input of a second select device), and the source of the TFT 1212 (referred to as an output of the second select device) is connected to the pixel electrode 608. The gate 1220 (referred to as first select device enable) of TFT 1210 is connected to a first matrix-common frame selection signal. The gate 1222 (referred to as second select device enable) of TFT 1212 is connected to a second matrix-common frame selection signal. The control gate input (labeled CG) 410 of each NVM unit is connected to a matrix-common control gate signal. The programming input (labeled P) 904 of each NVM unit is connected to a matrix-common programming signal 1218. The erase input (labeled E) 414 of each NVM unit is connected to a matrix-common erase signal.

To program the NVM units, data is first written to every RAM cell throughout the matrix. This is done using each gate line 806 and each source line 1206 and 1208, in the manner of a conventional active matrix LCD. Once the data has been written to every RAM cell, programming is performed as described in the second embodiment: a large positive voltage is applied to the matrix-common control gate 410, whilst a large negative voltage is applied to the matrix-common programming input 904. These voltages are held for an appropriate period of time, typically 100 ms. The only NVM units to be programmed are those whose corresponding RAM cells have been programmed with zero volts. If a RAM cell has been programmed with a large negative voltage, its corresponding NVM cell will not be programmed.

Every NVM cell is erased simultaneously by applying a large negative voltage to the matrix-common control gate 410, whilst applying a large positive voltage to the matrix-common erase input 414. These voltages are held for an appropriate period of time, typically 100 ms.

The data from the first NVM unit 1202 is selected for display by applying a high selection voltage to the first matrix-common frame selection input 1220, whilst applying a low selection voltage to the second matrix-common frame selection input 1222. This causes TFT 1210 to conduct but not TFT 1212, connecting the output of the NVM cell 1202 to the pixel electrode 608. The data from the second NVM unit 1204 is selected for display by applying the high selection voltage to the second matrix-common frame selection input 1222, whilst applying the low selection voltage to the first matrix-common frame selection input 1220. This causes TFT 1212 to conduct but not TFT 1210, connecting the output of the NVM cell 1204 to the pixel electrode 608. The high and low selection voltages should be chosen to ensure that the frame selection TFTs 1210 and 1212 may be switched fully on and fully off, given the high and low voltage levels required at the pixel electrode.

Whilst FIG. 12 shows a pixel matrix having two NVM units per pixel, and capable of storing two complete frames of image data, it is equally possible to have several NVM units in each pixel. This could be achieved using several individual source lines per column of pixels, and several matrix-common frame selection signals.

Note that in the pixel shown in FIG. 12, each DRAM cell (corresponding to a particular NVM cell) is addressed with a separate source line, yet shares the same gate line. It is equally possible to design a pixel having multiple NVM and DRAM cells, where the DRAM cells share a single source line yet are connected to different gate lines.

Note also that the two bit architecture shown in FIG. 12 is capable of storing two separate images having one bit greyscale (i.e., black and white, in the case of a monochromatic display). However, it may also be used to store a single image having two bit (i.e., four level) greyscale. This may be achieved by rapidly switching between the two displayed frames, at a frequency higher than the human eye is capable of perceiving. The image that corresponds to the most significant bit should be displayed for twice as long as the image that corresponds to the least significant bit. In this way, the viewer will perceive a single image whose greyscale can take one of four levels.

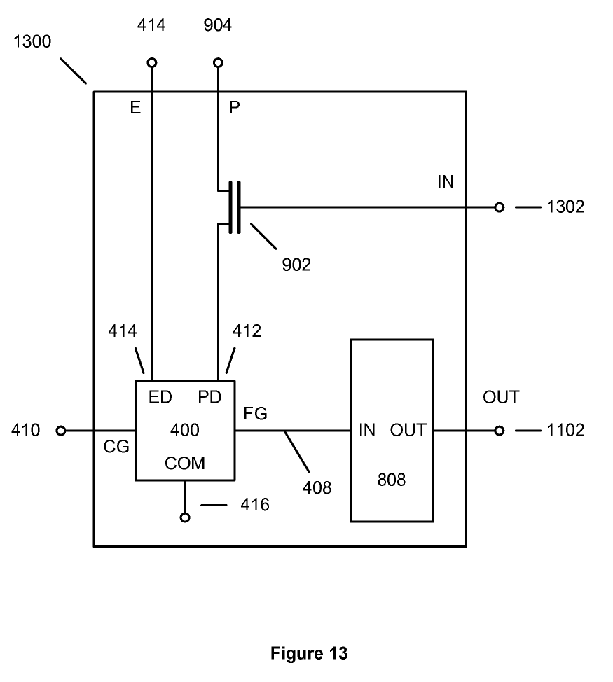

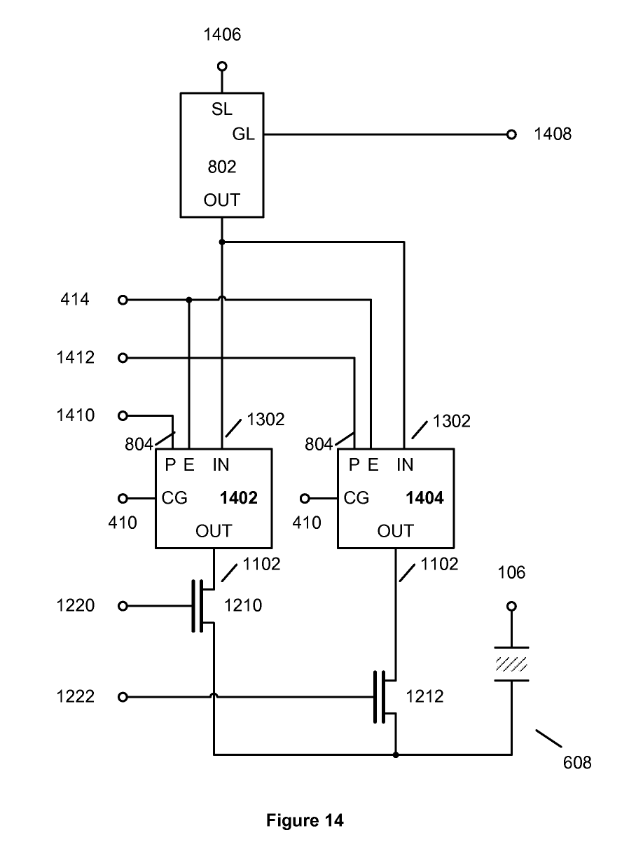

A fifth embodiment of the invention is shown in FIG. 13 and FIG. 14. The fifth embodiment is similar to the fourth embodiment, as multiple images may be stored within the pixel matrix. However, in the fifth embodiment one RAM cell per pixel is shared between each NVM unit. The fifth embodiment may require a smaller substrate area, and may therefore be preferable over the fourth embodiment.

FIG. 13 shows a schematic diagram of an ‘NVM unit’ 1300, containing an NVM cell 400, inversion circuitry 808 and a gating TFT 902. The gate of the gating TFT 902 forms a first programming input (labeled IN) 1302 of the NVM unit 1300. The source of the gating TFT 902 is connected to the programming input (PD) 412 of the NVM cell 400. The drain 904 of the gating TFT 902 forms a second programming input (labeled P) of the NVM unit 1300. The gate and drain of the TFT 902 may be referred to as memory unit first and second programming inputs, respectively, or collectively as memory unit programming input. The NVM cell may be a conventional NVM cell, such as the NVM cell shown in FIG. 4. The floating gate (labeled FG) 408 of the NVM cell is connected to the input (labeled IN) of the in-cell inversion circuitry 808. The in-cell inversion circuitry may be a conventional in-cell inversion circuit, such as the circuit shown in FIG. 6 and FIG. 7. The output of the in-cell inversion circuitry (labeled OUT, referred to as a memory unit output) forms the output 1102 of the NVM unit (labeled OUT). The control gate 410 of the NVM cell 400 forms an input (labeled CG, referred to as memory unit control gate) to the NVM unit. The sources 416 of the NVM cell's program and erase TFTs (COM) are connected to 0V. The NVM unit 1300 also includes an erase input (labeled E, referred to as memory unit erase input).

FIG. 14 shows the schematic diagram of a single pixel, which is provided with two identical NVM units 1402 and 1404 (first and second NVM units), of the kind shown in FIG. 13. A single RAM cell 802 is connected to a source line 1406 and a gate line 1408, in the manner of a conventional active matrix LCD. The output of the RAM cell (labeled OUT, referred to as VM cell output) is connected to the memory unit first programming input (labeled IN) 1302 of each NVM unit.

The output 1102 of NVM unit 1402 (labeled OUT, referred to as first memory unit output) is connected to the drain of a TFT 1210 (referred to as a first select device input), and the source of the TFT 1210 (referred to as a first select device output) is connected to the pixel electrode 608. The output 1102 of NVM unit 1404 (labeled OUT, referred to as second memory unit output) is connected to the drain of a TFT 1212 (referred to as a second select device input), and the source of the TFT 1212 (referred to as a second select device output) is connected to the pixel electrode 608. The gate 1220 (referred to as a first select device enable) of TFT 1210 is connected to a first matrix-common frame selection signal. The gate 1222 (referred to as a second select device enable) of TFT 1212 is connected to a second matrix-common frame selection signal. The control gate input 410 of each NVM unit (labeled CG) is connected to a matrix-common control gate signal. The memory unit second programming input (labeled P) 904 of the first NVM unit 1402 is connected to a first matrix-common programming signal 1410. The memory unit second programming input (labeled P) 904 of the second NVM unit 1404 is connected to a second matrix-common programming signal 1412. The erase input (labeled E) 414 of each NVM unit is connected to a matrix-common erase signal.

The NVM units are programmed one at a time. To program the first NVM unit 1402, data is first written to the RAM cell 802. This is done using each gate line 1408 and each source line 1406, in the manner of a conventional active matrix LCD. Once the data has been written to every pixel's RAM cell, programming is performed by applying a large positive voltage to the matrix-common control gate 410, whilst a large negative voltage is applied to the first matrix-common programming input 1410. The second matrix-common programming input 1412 is held at 0V throughout. These voltages are held for an appropriate period of time, typically 100 ms. Only the first NVM unit 1402 in each pixel is programmed, and even then only if the pixel's RAM cell has been programmed with zero volts. If a pixel's RAM cell has been programmed with a large negative voltage, its corresponding first NVM unit 1402 will not be programmed. The same procedure is used to program the second NVM cell 1404, except the second matrix-common programming signal 1412 is used in place of the first matrix-common programming signal 1410.

Every NVM cell is erased simultaneously by applying a large negative voltage to the matrix-common control gate 410, whilst applying a large positive voltage to the matrix-common erase input 414. These voltages are held for an appropriate period of time, typically 100 ms.

The data from the first NVM unit 1402 is selected for display by applying a high selection voltage to the first matrix-common frame selection input 1220, whilst applying a low selection voltage to the second matrix-common frame selection input 1222. This causes TFT 1210 to conduct but not TFT 1212, connecting the output of the NVM cell 1402 to the pixel electrode 608. The data from the second NVM unit 1404 is selected for display by applying a high selection voltage to the second matrix-common frame selection input 1222, whilst applying a low selection voltage to the first matrix-common frame selection input 1220. This causes TFT 1212 to conduct but not TFT 1210, connecting the output of the NVM cell 1404 to the pixel electrode 608. The high and low selection voltages should be chosen to ensure that the frame selection TFTs 1210 and 1212 may be switched fully on and fully off, given the high and low voltage levels required at the pixel electrode.

Whilst FIG. 12 shows a pixel matrix having two NVM units per pixel, and capable of storing two complete frames of image data, it is equally possible to have several NVM units in each pixel. This would require several matrix-common programming signals.

As with the previous embodiment, the circuit shown in FIG. 14 may be used to store two images having 1 bit greyscale (i.e., black and white), or a single image having two bit (i.e., four level) greyscale.

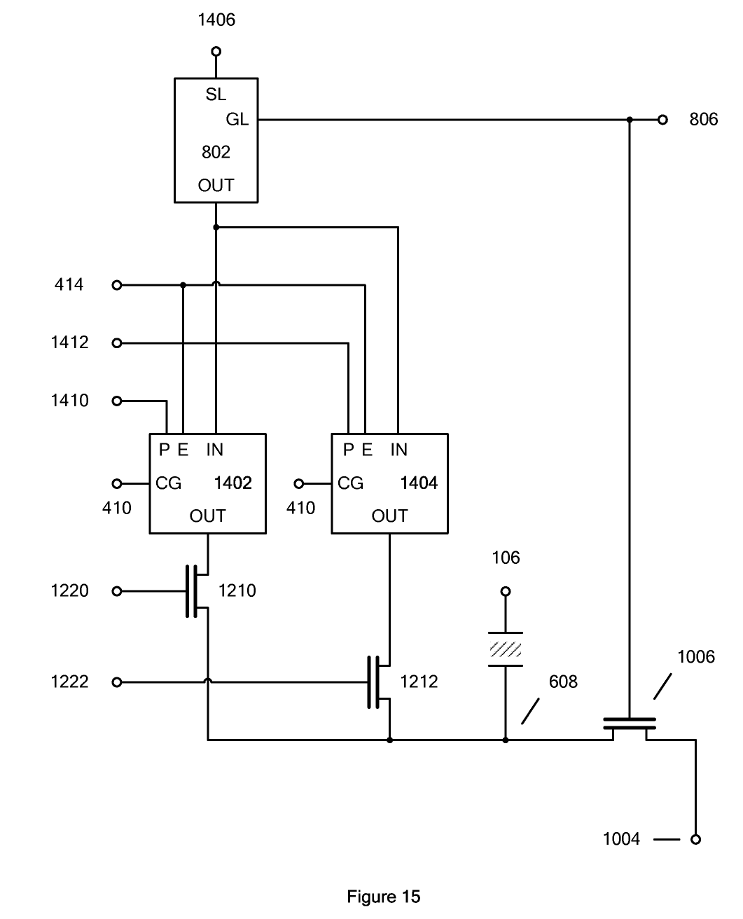

A sixth embodiment of the invention is shown in FIG. 15. FIG. 15 is identical to FIG. 14 but with the addition of a readout TFT 1006 and a column readout line 1004. The column readout line is common to every pixel in a given column of the pixel matrix. The drain of the readout TFT 1006 (referred to as the readout device output) is connected to the pixel electrode 608, whilst the source of the readout TFT (referred to as the readout device input) is connected to the column readout line. The gate of the readout TFT 1006 (referred to as readout device enable) is connected to the gate line 806 of the pixel.

These additional components allow the data stored in the NVM cells of each pixel to be read-out and verified after the cell has been programmed. Once the programming signal is no longer being issued to the node 904, one frame is selected for display using the frame selection lines 1220 and 1222. One particular gate line 806 may then be raised in voltage, causing the TFT 1002 to conduct, and connecting the output of each pixel in the row to its associated column readout line 1004. A column readout amplifier may be connected to each column line, to measure the output voltage produced by each pixel. Note that during readout, the voltage applied to the gate line must be chosen to allow the readout TFT 1002 to pass the voltage present at the pixel electrode 608. It may be preferable to apply one or more intermediate voltages to the matrix-common control gate 410 during readout, in order to infer the amount of charge held on the floating gate.

This sixth embodiment may be advantageous over the fifth in cases where it is necessary to verify that each NVM cell has been successfully programmed or erased.

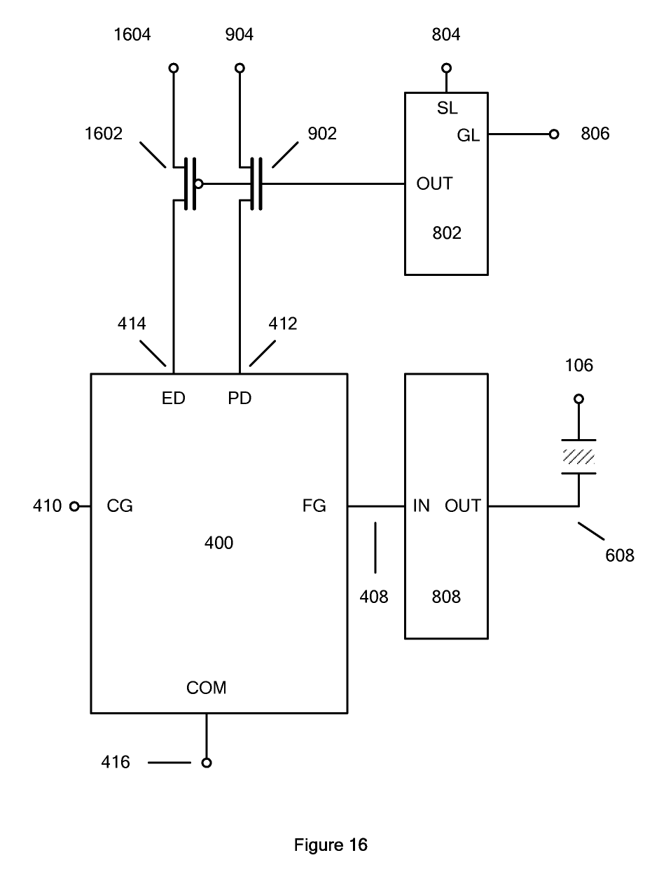

A seventh embodiment of the invention is shown in FIG. 16. FIG. 16 is identical to FIG. 9 but with the addition of a TFT 1602 that gates the signal applied to the drain 414 of the erase TFT within the NVM cell 400. Like the gate of the TFT 902, the gate of the TFT 1602 is connected to the output of the DRAM cell 802.

The additional TFT 1602 allows individual NVM cells to be selected for erasing, by programming each DRAM to an appropriate voltage before pulsing the pixel's erase input 1604 with a large positive voltage. By erasing only those NVM cells that have been programmed, it may be possible to increase the lifetime of the display. This seventh embodiment may therefore be advantageous over the second embodiment.

The TFT 1602 may be either a n-channel or a p-channel device. When the TFT 1602 is a p-channel device, and the erase input 1604 is pulsed to a large positive voltage, the DRAM must be programmed with an equally large positive voltage in order to inhibit erasing of the cell. To permit erasing of the cell, the DRAM should be programmed with 0V.

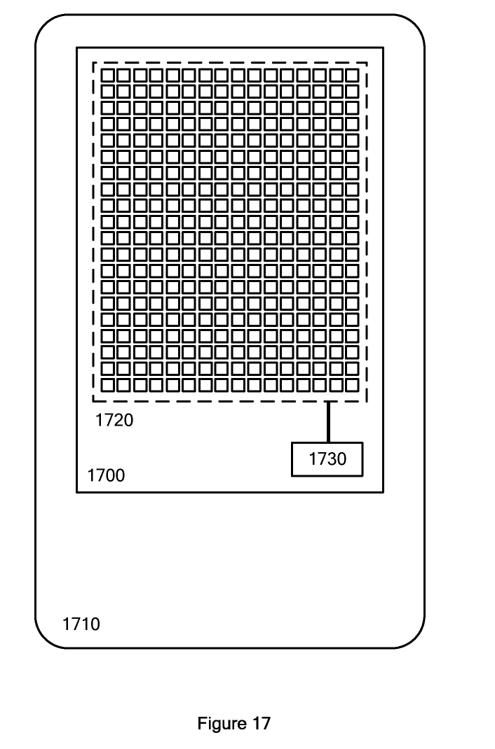

A system level block diagram is shown in FIG. 17. A display 1700, within a host device 1710, has a matrix 1720 of pixels, each of which contain both volatile and non-volatile memory cells. A programming logic block 1730, which is operatively coupled to the host device, the volatile memory cells and non-volatile memory cells, obtains image data from the host device 1710 and writes this image data to the volatile memory cell within each pixel. The data held in each volatile memory cell is then substantially simultaneously transferred to the corresponding non-volatile memory cell, as exemplified by the embodiments of the invention. The programming logic block 1730 may also supply the necessary signals to the matrix common programming input 904, and to the matrix common control gate 410.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The device and method according to the present invention find applicability in display devices, such as active matrix LCD devices. The device and method enable flash memory to be used with as a memory storage for image data of a pixel without the slow programming times associated with conventional systems.

1. A pixel of a display device, the pixel comprising:
a pixel electrode;
a volatile memory (VM) cell including a VM cell input for receiving data to be stored in the VM cell and a VM cell output for outputting data stored in the VM cell; and
a non-volatile memory (NVM) cell including an NVM program input operatively coupled to the VM cell output, and an NVM data output for providing image data stored in the first NVM cell to the pixel electrode.

2. An active matrix display, comprising:
a plurality of pixels as set forth in claim 1; and
programming logic operatively coupled to each of the plurality of pixels, wherein the programming logic is configured to substantially simultaneously program each pixel's NVM cell with data stored in each pixel's VM cell.

3. The device according to claim 2, wherein the programming logic is configured to program the NV cells row-by-row and then simultaneously program the NVM cell with the data stored in the VM cell.

4. The display according to claim 2, wherein each NVM cell comprises an NVM control gate, and the NVM control gate of each pixel of the plurality of pixels is electrically coupled to the NVM control gate of other pixels of the plurality of pixels.

5. The display according to claim 4, wherein each NVM cell comprises an NVM erase input, and the NVM erase input of each pixel of the plurality of pixels is electrically coupled to the NVM erase input of other pixels of the plurality of pixels.

6. The device according to claim 1, wherein the pixel further comprises inversion circuitry including an inversion input and an inversion output, the inversion input operatively coupled to the NVM data output of the NVM cell, and the inversion output operatively coupled to the pixel electrode, the inversion circuitry configured to invert a voltage applied to the pixel electrode.

7. The device according to claim 1, the pixel further comprising:
a gating device including a gating device input for receiving a current, a gating device output operatively coupled to the NVM program input, and a gating device enable operatively coupled to the VM cell output,
wherein the gating device is configured to electrically connect the gating device input to the gating device output based on a state of the gating device enable.

8. The device according to claim 1, wherein the pixel further comprises inversion circuitry including an inversion input and an inversion output, the inversion input operatively coupled to the NVM data output of the NVM cell, and the inversion output operatively coupled to the pixel electrode, the inversion circuitry configured to invert a voltage applied to the pixel electrode, wherein the VM cell, NVM cell, inversion circuitry and gating device form a first memory unit, the pixel further comprising:
a gating device including a gating device input for receiving a current, a gating device output operatively coupled to the NVM program input, and a gating device enable operatively coupled to the VM cell output, wherein the gating device is configured to electrically connect the gating device input to the gating device output based on a state of the gating device enable;
a second memory unit including another VM cell, NVM cell, inversion circuitry and gating device, the first and second memory units each having a memory unit input for receiving data to be stored in the VM cell of the respective memory unit, and memory unit output for providing image data to be displayed by the pixel;
a first select device including an input operatively coupled to the first memory unit output, an output operatively coupled to the pixel electrode, and an enable input configured to selectively couple the input of the first select device to the output of the first select device; and
a second select device including an input operatively coupled to the second memory unit output of the second memory unit, an output operatively coupled to the pixel electrode, and an enable input configured to selectively couple the input of the second select device to the output of the second select device,
wherein based on a state of the enable inputs of the first and second select devices, the memory unit output of the first or second memory unit is coupled to the pixel electrode.

9. The device according to claim 1, wherein the pixel further comprises inversion circuitry including an inversion input and an inversion output, the inversion input operatively coupled to the NVM data output of the NVM cell, and the inversion output operatively coupled to the pixel electrode, the inversion circuitry configured to invert a voltage applied to the pixel electrode, wherein the NVM cell, inversion circuitry and gating device form a first memory unit, the pixel further comprising:
a gating device including a gating device input for receiving a current, a gating device output operatively coupled to the NVM program input, and a gating device enable operatively coupled to the VM cell output, wherein the gating device is configured to electrically connect the gating device input to the gating device output based on a state of the gating device enable;
a second memory unit including another NVM cell, inversion circuitry and gating device, the first and second memory units each having a memory unit first and second programming inputs for receiving data to be stored in the respective NVM cell, and a memory unit output for providing image data to be displayed by the pixel, wherein the first memory unit input of each memory unit is operatively coupled to the VM cell output;
a first select device including an input operatively coupled to the first memory unit output, an output operatively coupled to the pixel electrode, and an enable input configured to selectively couple the input of the first select device to the output of the first select device; and
a second select device including an input operatively coupled to the second memory unit output, an output operatively coupled to the pixel electrode, and an enable input configured to selectively couple the input of the second select device to the output of the second select device,
wherein based on a state of the enable inputs of the first and second select devices, the memory unit output of the first or second memory unit is coupled to the pixel electrode.

10. The device according to claim 9, wherein the memory unit second input of the first and second memory units are coupled to different programming lines.

11. The device according to claim 1 wherein the VM cell input comprises a pixel gate line, the device further comprising:
a readout electrode; and
a readout device including a readout device input operatively coupled to the pixel electrode, a readout device output operatively coupled to the readout electrode, and readout device enable operatively coupled to the pixel gate line, the readout device configured to selectively couple the readout device input to the readout device output based on a state of the readout device enable.

12. The device according to claim 11, wherein the readout electrode of pixels of a column are electrically connected to each other.

13. The device according to claim 1, wherein the NVM cell of the pixel further includes an NVM erase input for erasing data stored in the NVM cell, the device further comprising:
an erase device including an erase device input for receiving an erase voltage, an erase device output operatively coupled to the NVM erase input, and an erase device enable operatively coupled to the VM cell output,
wherein the erase device is configured to couple the erase input to the erase output based on a state of the erase device enable.

14. The device according to claim 1, wherein the VM cell input comprises a pixel gate line and a pixel source line, and data provided on the pixel source line is stored in the VM cell based on a state of the pixel gate line.

15. A method for storing data to be displayed on a display device that includes a liquid crystal display having a plurality of pixels, each pixel including a volatile memory (VM) cell and a non-volatile memory (NVM) cell, comprising:
writing data in the VM cell of each pixel; and
substantially simultaneously writing the data stored in each VM cell into the NVM cell of each pixel.

16. The method according to claim 15, wherein writing data in the VM cell includes writing the data row-by-row.

17. The method according to claim 15, wherein substantially simultaneously writing the data stored in each VM cell into the NVM cell includes writing to the NVM memory cell without using pixel addressing.

18. The method according to claim 15, further comprising inverting a voltage applied to a pixel electrode.

19. The method according to claim 15, further comprising providing leakage current to the NVM cell directly from the VM cell.

20. The method according to claim 15, further comprising providing leakage current to the NVM cell from a switching device controlled by an output of the VM cell.
